(19) United States
(12) Patent Application Publication
(10) Pub. No.: US 2021/0349261 A1
(43) Pub. Date: Nov. 11, 2021

(54) Device with a Waveguide with a Support Structure Comprising a Polymer Layer and Method for its Fabrication

(71) Applicants: Floria Ottonello Briano, Stockholm (SE); Valentin Dubois, Solna (SE); Simon Bleiker, Stockholm (SE); Arne Quellmalz, Stockholm (SE); Frank Niklaus, Taby (SE); Kristinn B. Gylfason, Solna (SE)

(72) Inventors: Floria Ottonello Briano, Stockholm (SE); Valentin Dubois, Solna (SE); Simon Bleiker, Stockholm (SE); Arne Quellmalz, Stockholm (SE); Frank Niklaus, Taby (SE); Kristinn B. Gylfason, Solna (SE)

(21) Appl. No.: 17/282,343

(22) PCT Filed: Mar. 8, 2019
(86) PCT No.: PCT/SE2019/050203

§ 371 Date: Apr. 1, 2021

(30) Foreign Application Priority Data
Mar. 14, 2018 (SE) 1850285-6
Mar. 14, 2018 (SE) 1850286-4

(51) Int. Cl. G02B 6/122; G02B 6/13

(52) U.S. Cl. CPC G02B 6/122; G02B 6/13

(57) ABSTRACT

In an embodiment a device includes a device layer, a substrate defining a substrate plane extending through a point of the substrate being closest to the device layer, a waveguide configured to guide an electromagnetic wave, wherein the waveguide extends in a length direction in the device layer, and wherein the waveguide has a width in a device layer plane in a direction perpendicular to the length direction and a height out of the device layer plane in the direction perpendicular to the length direction and a support structure, wherein the support structure extends from the substrate to the device layer to support the waveguide on the substrate.

This patent application is a national phase filing under section 371 of PCT/SE2019/050203, filed Mar. 8, 2019, which claims the priority of Swedish patent application 1850286-4, filed Mar. 14, 2018, and Swedish patent application 1850285-6, filed Mar. 14, 2018, all of which is incorporated herein by reference in its entirety.

### TECHNICAL FIELD

The invention relates to a device with a waveguide supported by a support structure and to a method for fabrication of such a device.

### BACKGROUND

Optical sensing using the absorption bands of various gases in the visible or infrared (IR) wavelength range is an established method. The absorption may be measured in cavities with mirrors, in order to achieve an effective interaction length which is longer than the physical size of the cavity. This approach is limited by the optical losses in the mirrors. For IR, the source is often a broadband incandescent lamp. To get a spectral resolution, optical spectral analysis is then needed. Detectors can be thermal or semiconductor-based photon detectors.

To make sensitive devices with a long optical path-length, either high quality mirrors must be used or the physical path, and hence the device size, must be long. For many applications, low gas flows and the large volume of the gas chamber limit the response speed of the sensor.

International Patent Application Publication WO 2017/003353 describes a sensor device for detecting a component in a fluid such as a gas. The sensor device comprises a planar substrate, a waveguide for guiding an electro-magnetic wave and a support structure extending from the substrate to the waveguide. A method for detecting a component in a gas comprises the steps of providing the waveguide in contact with the gas, transmitting an electromagnetic wave into a first portion of the waveguide, allowing the electromagnetic wave to interact with the fluid in a region of an evanescent wave of the electromagnetic wave around the waveguide and detecting the electromagnetic wave at a second portion of the waveguide. The component in the gas is determined based on the detected electromagnetic wave at the second portion. The width of the support structure varies along the length direction of the waveguide and the waveguide is of a material of a first composition and the support structure is of a material of a second composition. In this way, the influence of the support structure on the waveguiding properties is decreased. In order to minimize the influence of the support structure on the waveguiding properties and to increase the sensitivity of the sensor device it is advantageous to have the waveguide partly free-hanging.

It is desirable to provide gas sensors for mid-IR wavelengths. However, it is difficult to fabricate efficient gas sensors of the above described type with waveguides. This is partly due to the problems with leakage of optical energy from the waveguides into the substrate, and also due to lack of substrates with suitable materials and dimensions.

Apart from a light source and a detector it might also be desirable to include electronics for driving of the light source and electronics for readout from the detector.

Apart from a sensor device, also other devices may be contemplated which comprise an elongated structure extending in a length direction in a device layer and being supported on a first layer by a support structure.

One possible approach for fabricating a sensor device as is described in International Patent Application Publication WO 2017/003353 is to use an SOI (silicon on insulator) wafer as starting material so that the base layer is a silicon layer, the intermediate layer is a silicon dioxide layer and the device layer is a silicon layer.

Such wafers are readily available which is advantageous. The silicon dioxide layer in such a device is commonly known as a BOX (buried oxide) layer. A problem, however, with using SOI as starting material is that there will be inherent stresses in the device layer in SOI wafers. The problem with inherent stresses increases with increasing thicknesses of the BOX layer and decreasing thickness of the device layer. This puts a limit on the possible thickness combinations that can be produced and, hence, are available. Stresses in the device layer may also cause the waveguides to bend and may even cause failures in the fabrication process. If the waveguides bend downwards, they get closer to the base layer and this increases the losses. A thick oxide layer would be desirable to achieve a large separation distance between the waveguide and the base layer. A large separation distance between the waveguide and the base layer is advantageous to minimize the losses in the waveguide.

For gas sensing it would be advantageous to use wavelengths in the IR wavelength range. The wavelengths of interest are preferably within 3-12 μm, but wavelengths in the near-infrared shorter and up to about 100 μm might be used. In order to fabricate a gas sensor for this wavelength sensor it is necessary to provide a waveguide with low losses in said wavelength region. It is however very difficult to fabricate a waveguide with low losses in said wavelength range with prior art methods. This is partly due to lack of availability of suitable substrates in terms of materials and dimension.

### SUMMARY

Embodiments provide a device and a method for its fabrication, which device comprises a waveguide, supported on a substrate, for guiding an electromagnetic wave, with which device at least one of the problems with the prior art is alleviated.

Other embodiments provide a device and a method for its fabrication, which device comprises a waveguide supported on a substrate, which waveguide is arranged for guiding an electromagnetic wave, with which device the problem of the prior art with mechanical stresses in the device layer is alleviated.

Yet other embodiments provide a device and a method for its fabrication, which device comprises a waveguide supported on a substrate, which waveguide is arranged for guiding an electromagnetic wave, with which device the problem with losses of electromagnetic energy from the waveguide is at least alleviated, for wavelengths in the IR range, between 0.75 μm to about 100 μm, and especially in the wavelength range from 3-12 μm.

According to a first aspect a device is provided comprising a device layer, a substrate defining a substrate plane extending through the point of the substrate being closest to the device layer. The device also comprises a waveguide for guiding an electromagnetic wave. The waveguide extends in a length direction L in the device layer, has a width w in the device layer plane in a direction perpendicular to the length direction L, and a height h out of the device layer plane in a direction perpendicular to the length direction. The device also comprises a support structure, wherein the support structure extends from the substrate to the device layer to support the waveguide on the substrate. A device layer plane extends parallel to the substrate plane through the point of the device layer being supported via the support structure that is closest to the substrate plane. The device according to the first aspect is characterized in that the device layer is of a different material than a polymer, and that the support structure comprises a polymer layer. A comparison cross section extends, parallel to the substrate plane, through the polymer layer at a spacing y perpendicularly from the substrate plane and extends perpendicularly to the length direction L to a breadth x, equal to the width w of the waveguide, from a side of the support structure being closest to the waveguide. The spacing y is chosen to maximize a ratio r of the area of the polymer layer within the comparison cross section to the area of the support structure within the comparison cross section. The ratio r is at least 0.5.

The support structure extends along the length direction of the waveguide. The waveguide may have a curved shape such that the length direction follows the direction of the waveguide. There might be waveguide branches. The support structures do not have to be elongated nor parallel to the waveguide.

With a device according to the first aspect the problem with mechanical stresses in the waveguide is at least alleviated. This is due to the polymer layer, which allows the device, and thus the waveguide, to be very thin while the polymer layer may be thick without inducing significant stresses in the device layer.

Furthermore, with a device according to the first aspect the problem with losses from the waveguide is at least alleviated. The polymer layer decrease losses in the waveguide due to reduced absorption. At the same time, the waveguide may be thin. Thus, a large part of the electromagnetic field is outside the waveguide, i.e., the evanescent field is outside the waveguide. This combination of properties is optimal for sensing application using IR light.

The device layer may be essentially parallel to the substrate plane. The device is preferably produced using standard microfabrication techniques, which will result in the device layer plane being essentially parallel to the substrate plane. However, after removal of material between the device layer and the substrate the device layer may become slightly waved due to internal stresses in the device layer. Thus, in the final device the device layer might not be perfectly parallel to the substrate plane. Also, the support structure will have essentially the same desired height in all positions in which the device layer is supported. However, the support structure might still have small variations in height in different positions in which the device layer is supported. If the support structure has the same height in all points in which it supports the device layer the device layer plane will extend parallel to the substrate plane through all points of the device layer being supported via the support structure.

As specified above the device layer plane extends parallel to the substrate plane through the point of the device layer being supported via the support structure that is closest to the substrate plane. Thus, the device layer may be closer to or further from the substrate plane between the points of the device layer being supported via the support structure. With regard to the substrate it is normally flat before microfabrication processing. However, during processing material may be removed from the substrate resulting in a surface of the substrate which is not perfectly flat.

The polymer layer may be in contact with the device layer. Such an arrangement minimizes the losses from the waveguide. However, it is also possible to have an additional layer between the polymer layer and the device layer/waveguide.

The ratio r of the area of the polymer layer within the comparison cross section to the area of the support structure within the comparison cross section is at least 0.5 as stated above.

However, in order to minimize the losses from the waveguide the ratio r is at least 0.80, preferably at least 0.90 and most preferred 0.95.

Another important feature for minimizing the losses from the waveguide is to have a large distance D2 perpendicular to the substrate plane, between the device layer plane, and thus also the waveguide, and the substrate plane. The distance D2 may be as small as 5 nm. However, in order to minimize the losses from the waveguide, the distance D2 may be at least 2 μm, preferably at least 3 μm, more preferably 30.1 μm, more preferably at least 4 μm, more preferably at least 6 μm, and most preferably 10 μm. The preferred distance between the device layer plane and the substrate plane depends on the wavelength. Preferably, the thickness of the waveguide is smaller than the wavelength. As the primary focus is to provide a device with a waveguide for the wavelengths in the mid-IR wavelength range, the distance between the device layer plane and the substrate plane preferably is as specified above. It has not been possible to achieve such distances perpendicular to the substrate plane, between the device layer plane and the substrate plane in the prior art without large mechanical stresses in the device layer. However, by introducing the polymer layer it is possible to increase the distance.

The maximum distance Dl, perpendicular to the substrate plane, consisting of free-space between the waveguide and any solid material below the waveguide can be zero. This means that the waveguide supported by material over its entire surface facing the substrate. However, in order to minimize losses from the waveguide, the ratio between the maximum distance Dl, perpendicular to the substrate plane, consisting of free-space between the waveguide and any solid material below the waveguide, and the waveguide height h may be more than 6, i.e. Dl/h>6, preferably Dl/h>8, and most preferred Dl/h>10.

The ratio of the distance D2, perpendicular to the substrate plane, between the device layer plane and the substrate plane to the height h of the waveguide may be more than 6, i.e. D2/h>6, preferably D2/h>8, and most preferred D2/h>10. A large ratio between the maximum distance Dl, perpendicular to the substrate plane, consisting of free-space between the waveguide and any solid material below the waveguide, and the waveguide height h may be achieved by having a thick polymer layer and/or a thin device layer. It may however also be achieved by removal of material from the substrate.

With a device the problem with losses from the waveguide is at least alleviated. This is due to the surprising effect of having the specified separations D1 and D2. With the specified separations the losses due to substrate leakage are minimized, because the suspended waveguide is far enough from the substrate. At the same time, the waveguide is thin. Thus, a large part of the electromagnetic field is outside the waveguide, i.e., the evanescent field is outside the waveguide. This combination of properties is optimal for sensing applications using IR light.

The material of the support structure in contact with the device layer may be different from the material in the device layer, and the material of the support structure in contact with the substrate may be different from the material in the substrate. By having the material of the support structure chosen in this way, the losses of electromagnetic energy from the waveguide is reduced further. Another motivation is the simplified fabrication process: materials of different kind can be structured selectively to each other. In case the support structure is made of a single material, the material in the support structure, preferably, is different from the material in the device layer and the material in the substrate. However, in case the support structure is made of layers of different materials, the material of the support structure in contact with the substrate may be the same material that is used in the waveguide.

The device layer may comprise a substructure, comprising at least one subelement, arranged at a distance from the waveguide, wherein the waveguide is connected to the substructure with connection means in the device layer, and wherein the support structure extends from the substrate to the substructure. By having a substructure as specified above the side of the waveguide facing the substrate may be completely free from material which minimizes the losses through this side of the waveguide. However, in order to provide suspension of the waveguide, connection means have to be provided in the device layer.

The connection means may be in the form of a membrane extending along each side of the waveguide, wherein the membrane has a height being no more than 98% of the height of the waveguide, preferably no more than 95% of the height of the waveguide, and most preferred no more than 80% of the height of the waveguide. The difference in height between the waveguide and the membrane is sufficient to confine the electromagnetic wave in the waveguide. A membrane is quite easy to produce and provides an even support for the waveguide. Due to the fabrication process of a membrane, the membrane might contain holes which are necessary if material needs to be removed underneath by under etching.

The substructure may comprise a plurality of subelements. By having the substructure divided in a plurality of subelements the losses of electromagnetic energy from the waveguide may be further reduced. Another benefit from having subelements is that the footprint of the substructure is minimized. Thus, area is made free for other components.

The support structure may comprise a plurality of support elements extending from the substructure. By having the support structure divided into a plurality of support elements the losses of electromagnetic energy from the waveguide is minimized further. Depending on the arrangement of the device the device may or may not comprise additional layers on top of the substrate which form part of the support structure.

Each support element may extend from a subelement to the substrate. This arrangement of the support elements further reduces the losses from the waveguide. Another advantage is that the footprint of the support element is minimized.

The connection means may comprise a plurality of bridges connecting the waveguide with the substructure. By having the connection means divided in a plurality of bridges the losses of electromagnetic energy through the connection means is minimized. The bridges may have a smaller height than the waveguide to further enhance the confinement of the electromagnetic wave in the waveguide and to thereby reduce the losses.

The ratio of the distance D₃ between the support structure and the waveguide to the width w of the waveguide is 0.5-100, preferably 1-10, and most preferred 2-5. With the ratio in said intervals the losses from the waveguide are minimized. Even if said ratio may be as high as 100 it is favorable to have said ratio below 10 in order to minimize the space for the waveguide and support structure, and to increase mechanical stability of the device.

The support structure may extend from the substrate to the waveguide. This is an alternative to having the waveguide suspended in substructures. The advantages of having this structure are simplified fabrication and minimized footprint area.

When the support structure extends from the substrate to the waveguide the ratio r of the area of the polymer layer within the comparison cross section to the area of the support structure within the comparison cross section may be at least 0.95, preferably at least 0.98, and most preferred at least 0.99. The loss from the waveguide is more sensitive to the material in the support structure when the support structure extends from the substrate to the waveguide instead of to the subelements.

The polymer layer may extend over the entire cross section area of the support structure in the comparison cross section. In this way the losses are minimized compared to the case of having metal extending from the waveguide.

The width of the support structure at the point of support of the waveguide may be smaller than the width w of the waveguide. In order to minimize losses of electromagnetic energy from the waveguide through the support structure the contact area between the support structure and the waveguide should be minimized.

The support structure may comprise a plurality of support elements such that the waveguide is free-hanging between two adjacent support elements. This further reduces the contact area between the support structure and the waveguide and thus minimizes the losses of electromagnetic energy through the support structure.

When no additional layers are arranged on the substrate, each support element may extend from the waveguide to the substrate. This further reduces losses from the waveguide.

At least one of the support elements may be made entirely of a polymer. This further reduces the losses from the waveguide. A support element made entirely of polymer may be formed from a polymer layer between the device layer and the substrate.

It is not only the maximum distance Dl, perpendicular to the substrate plane, consisting of free space between the waveguide and any solid material below the waveguide, that is of interest to minimize losses from the waveguide. It is also important to keep a large portion of the waveguide free from contact with any material. It is especially important to keep the side of the waveguide facing the substrate and the side of the substrate facing away from the substrate free from any material. This is due to the fact that these two sides have the largest effect on the losses of the electromagnetic wave. It is usually no problem to keep the side of the waveguide facing away from the substrate free from contact with any other material. Depending on how the waveguide is suspended on the substrate the ratio of the side of the waveguide, facing the substrate, being free from contact with any material varies.

According to the first alternative described above the device layer comprises a substructure, comprising at least one subelement, arranged at a distance from the waveguide. The waveguide is connected to the substructure with connection means in the device layer, and the support structure extends from the substrate to the substructure. In this case the side of the waveguide facing the substrate is preferably free from contact with any material. In this case the waveguide is only in contact with the connection means in the device layer. The width of the waveguide is preferably at least 5 times the height of the waveguide. Thus, the surface facing the substrate and the surface facing away from the substrate are considerably larger than the sides between said surfaces. Also, using normal manufacturing methods the quality of the surface facing the substrate and the surface facing away from the substrate have a considerably higher quality compared to the side surfaces between said surfaces. This results in that the surfaces facing the substrate and the surface facing away from the substrate being more important with respect to losses of the electromagnetic wave in the waveguide.

In the second case described above the support structure extends from the substrate to the waveguide. The advantage of having the support structure extending from the substrate is that the footprint of the substrate is minimized for a given area of the waveguide. In this case the losses may be minimized by minimizing the contact area between the support structure and the waveguide. This may be done by having the width of the support structure smaller than the width of the waveguide. Preferably, the support structure is also divided into a plurality of support elements which are separated in the longitudinal direction of the waveguide. With a plurality of such separated support elements the waveguide comprises sections between the support elements which are free-hanging and free from contact with any material.

The two above described cases can be summarized in the following way. The waveguide preferably comprises at least sections, separated in the length direction of the waveguide, which sections are free from contact with any material on the surface facing the substrate. Preferably, as much as possible of the waveguide is free from contact with any material on the surface facing the substrate and on the surface facing away from the substrate.

The width w of the waveguide may at least 5 times the height of the waveguide. The evanescent field becomes stronger if one of the height and the width of the waveguide is made smaller than the wavelength. This is advantageous if the device is to be used as, e.g., a gas sensor. Furthermore, when fabricating a waveguide, the top and bottom surfaces can be made very smooth while the side's surface will have a higher roughness than the top and bottom sides. A higher roughness will result in higher losses per surface area. By making the side surfaces smaller than the top and bottom surfaces the losses may be minimized while still retaining the waveguiding properties of the waveguide. Thus, it is very favorable to have a width to height ratio of more than 5 in order to minimize the losses.

The height of the waveguide may be smaller than the wavelength of the electromagnetic wave to be guided. This is advantageous in order to control the modes of the electromagnetic wave in the waveguide properly. With the height of the waveguide being smaller than the wavelength of the electromagnetic wave to be guided the modes of the electromagnetic wave may become loosely confined, which is advantageous it the device is to be used for, e.g., gas sensing.

The waveguide may be arranged for guiding an electromagnetic wave with a wavelength within the range of 0.4-100 nm, preferably 1.2-20 nm, and most preferred within 3-12 μm. These wavelengths are useful when the device is to be used as a gas sensor.

The thickness of the polymer contact layer may be 5 nm to 100 μm, preferably 200 nm to 50 μm, and most preferably 3-20 μm. The low part of the first interval requires the support structure to be constituted by other materials apart from the polymer contact layer(s). In order to provide a reliable polymer contact layer(s) the thickness of the polymer contact layer(s) is preferably 200 nm-50 nm, most preferably 3-20 μm.

The support structure may comprise conductive material extending from the substructure. The conductive material may provide electrical connection between the substructure and devices below the device layer.

The support structure may comprise conductive material extending from the device layer to the substrate. The extension of the conductive material from the substructure depends on where the active devices and metal lines are situated. By having a conductive material extending from the substrate to the substructure electrical connection between the device layer and the substrate is enabled. This may be useful for example when active devices are arranged on or in the device layer and are to be connected to devices in or on the substrate.

The device may comprise metal lines and/or active devices, such as transistors, light sources and detectors, in or in contact with the device layer and/or the substrate and/or between the device layer and the substrate. This enables integration of suspended waveguides on top of pre-processed wafers with e.g. CMOS circuits for readout/control of source and detectors.

According to a second aspect a method for fabrication of a device is provided. The device comprises a device layer, a substrate defining a substrate plane extending through the point of the substrate being closest to the device layer. The device also comprises a waveguide for guiding an electromagnetic wave, the waveguide extending in a length direction L in the device layer, the waveguide having a width w in the device layer plane in a direction perpendicular to the length direction L, and a height h out of the device layer plane in a direction perpendicular to the length direction. The device also comprises a support structure, which extends from the substrate to the device layer to support the waveguide on the substrate. A device layer plane extends parallel to the substrate plane through the point of the device layer being supported via the support structure that is closest to the substrate plane. The method comprises the steps of providing a handling substrate on which a device layer is arranged, the handling substrate and the device layer forming a device layer assembly, providing a substrate, providing a polymer contact layer on the substrate and/or on the device layer assembly, on the same side of the handling substrate as the device layer. The method also comprises the steps of attaching the device layer assembly on the substrate with the device layer arranged between the handling substrate and the substrate, so that the polymer contact layer(s) form the polymer layer, removing the handling substrate after attachment of the device layer assembly to the substrate, removing material from the device layer to form the waveguide, and removing material from the polymer contact layer(s) to form the support structure. The device layer is of a different material than a polymer. The support structure comprises a polymer layer. A comparison cross section extends, parallel to the substrate plane, through the polymer layer at a spacing y perpendicularly from the substrate plane and extends perpendicularly to the length direction L to a breadth x, equal to the width w of the waveguide, from a side of the support structure being closest to the waveguide. The spacing y is chosen to maximize a ratio r of the area of the polymer layer within the comparison cross section to the area of the support structure within the comparison cross section. The ratio r is at least 0.5.

The method of using a sacrificial wafer as in the method according to the second aspect is known per se from U.S. Pat. No. 7,067,345, which patent is hereby incorporated by reference in its entirety.

The method makes it possible to provide suspended waveguides on top of pre-processed wafers with, e.g., CMOS circuits for readout/control of source and detectors. The method according to the second aspect also provides a favorable method of fabricating a device according to the first aspect.

The process step to release the waveguide from the support structure may be performed using an O₂-plasma or solvents. These methods are compatible with many materials which means that polymer support allows process steps before release etch such as, e.g., material deposition.

The method may comprises the steps of removing material from the device layer to form the waveguide and removing material between the device layer and the substrate to form the support structure, so that the side of the waveguide facing the substrate is at least partly free from contact with any solid material, so that the ratio of the largest distance Dl, perpendicular to the substrate plane, between a free surface of the waveguide facing the substrate and any solid material to the height h of the waveguide is more than 6, i.e. Dl/h>6, preferably Dl/h>8, and most preferred Dl/h>10, and so that the ratio of the distance D2, perpendicular to the substrate plane, between the device layer plane and the substrate plane to the height h of the waveguide is more than 6, i.e. D2/h>6, preferably D2/h>8, and most preferred D2/h>10.

In the prior art, silicon layers being supported on oxide supports on a silicon substrate have been possible to fabricate using so called silicon on insulator wafers (SOI wafers). The silicon device layer in SOI wafers is difficult to get stress free. The problem with inherent stresses in the silicon device layer becomes worse with increasing thickness of the insulator/oxide and decreasing thickness of the device layer. Furthermore, the above specified values of Dl/h and D2/h are not possible to achieve using commercially available SOI wafers.

The method provides a stress-free device layer and hence a stress-free waveguide.

The removal of material between the device layer and the substrate may comprise at least one step of anisotropic or isotropic oxygen plasma etching, or combinations thereof.

The step of forming the waveguide may be performed after the step of removing the handling substrate. This is the most straight forward method for fabricating the device. If the waveguide is formed before the step of removing the handling substrate it must be formed also before attachment of the device layer assembly on the substrate. Thus, care must be taken during the following process steps in order not to harm the waveguide to guarantee sufficient alignment of the waveguide to any existing structure or component present on/in the substrate and to guarantee sufficient alignment of the waveguide to following process steps such as, e.g., photolithography.

The step of forming the support structure may be performed after the step of removing the handling substrate. This provides the same advantages as was mentioned for the previous feature.

The thickness of the polymer layer may be formed to be in the interval 5 nm to 100 μm, preferably 200 nm-50 μm, most preferably 3-20 μm. The low part of the first interval requires the support structure to be constituted by other materials apart from the polymer contact layer(s). In order to provide a reliable polymer contact layer(s) the thickness of the polymer contact layer(s) is preferably 200 nm-50 μm, most preferably 3-20 μm.

The method may comprise the steps of forming, in the device layer, a substructure comprising at least one subelement arranged at a distance from the waveguide, and forming, in the device layer, connection means with which the waveguide is connected to the substructure. Wherein the support structure is formed to extend from the substrate to the substructure. By forming such substructures, the side of the waveguide facing the substrate may be completely free from material. This minimizes the losses through this side of the waveguide. However, in order to provide suspension of the waveguide, connection means have to be provided in the device layer.

The substructure may comprise a plurality of subelements. By having the substructure divided in a plurality of subelements the losses of electromagnetic energy from the waveguide may be further reduced. Another benefit from having subelements is that the footprint of the substructure is minimized. Thus, area is made free for other components.

The connection means may be formed as a plurality of bridges. By forming the connection means in the form of a plurality of bridges the losses of electromagnetic energy through the connection means is minimized. The bridges may have a smaller height than the waveguide to further enhance the confinement of the electromagnetic wave in the waveguide and to thereby reduce the losses. Another alternative is to form the connection means as membranes as was described above in relation to the first aspect.

The method may comprise the steps of removing material in regions between the substructure and the substrate and forming a support element in each one of said regions. With these method steps a device is fabricated in which the losses of electromagnetic energy from the waveguide may be minimized.

The support elements may be fabricated to comprise a conductive material. This enables integration of suspended waveguides on top of pre-processed wafers with e.g. CMOS circuits for readout/control of source and detectors in or on the device layer.

The support structure may be formed to extend from the substrate to the waveguide. This is an alternative to having the waveguide suspended in substructures. This enables a maximized area of the waveguide on the device. The advantages of having this structure is simplified fabrication and minimized footprint area.

The method may comprise the step of removing material from the substrate below the waveguide. This step increases the maximum distance perpendicular to the substrate plane, consisting of free-space between the waveguide and any solid material below the waveguide. This leads to reduced losses from the waveguide. With this step a large distance may be achieved between the waveguide and the substrate while still using a thin polymer layer. This method step requires the support structure to extend from the substrate to a substructure connected to the waveguide with connection means.

The method may comprise at least one processing step chosen from photolithography and/or material deposition and/or thermal processing and/or surface functionalization and/or layer transfer processes and/or wet/dry etching processes. These are standard processing steps in wafer fabrication and are possible to combine with the method according to the second aspect.

The method may comprise the step of forming metal lines and/or active devices, such as transistors, light sources and detectors. The metal lines and/or active devices may be arranged, in or in contact with the device layer and/or the substrate and/or between the device layer and the substrate. This enables integration of suspended waveguides on top of pre-processed wafers with e.g. CMOS circuits for readout/control of source and detectors.

The removal of polymer from the polymer layer may comprise at least one step of anisotropic or isotropic oxygen plasma etching, or combinations thereof. Oxygen plasma etching is a favorable method for removal of material from the polymer layer. This is because oxygen plasma etching is compatible with many materials and provides good process control. Also, the problem of stiction does not exist with oxygen plasma etching. By having anisotropic and isotropic etching steps it is possible to obtain various shapes of the support structure enabling, e.g., high aspect ratio pillars.

According to a third aspect a device is provided, which comprises a device layer, a substrate defining a substrate plane, extending through the point of the substrate being closest to the device layer, a waveguide for guiding an electromagnetic wave, the waveguide extending in a length direction L in the device layer, the waveguide having a width w in the device layer plane in a direction perpendicular to the length direction, and a height h out of the device layer plane in a direction perpendicular to the length direction. The waveguide is supported on the substrate via a support structure extending from the substrate to the device layer. A device layer plane extends parallel to the substrate plane through the point of the device layer being supported via the support structure that is closest to the substrate plane. The side of the waveguide facing the substrate is at least partly free from contact with the support structure. The device according to the first aspect is characterized in that the ratio of the largest distance Dl, perpendicular to the substrate plane, between a free surface of the waveguide facing the substrate and any solid material to the height h of the waveguide is more than 6, i.e. Dl/h>6, preferably Dl/h>8, and most preferred Dl/h>10. The ratio of the distance D2, perpendicular to the substrate plane, between the device layer plane and the substrate plane to the height h of the waveguide is more than 6, i.e. D2/h>6, preferably D2/h>8, and most preferred D2/h>10.

With a device the problem with losses from the waveguide is at least alleviated. This is due to the surprising effect of having the specified separations D1 and D2. With the specified separations the losses due to substrate leakage are minimized, because the suspended waveguide is far enough from the substrate. At the same time, the waveguide is thin. Thus, a large part of the electromagnetic field is outside the waveguide, i.e., the evanescent field is outside the waveguide. This combination of properties is optimal for sensing application using IR light.

The features described in relation to the first aspect are combinable with the device according to the third aspect.

According to a fourth aspect a method for fabrication of a device is provided. The device to be fabricated comprises a device layer, and a substrate defining a substrate plane extending through the point of the substrate being closest to the device layer. The device also comprises a waveguide for guiding an electromagnetic wave, the waveguide extending in a length direction L in the device layer, the waveguide having a width w in the device layer plane in a direction perpendicular to the length direction L, and a height h out of the device layer plane in a direction perpendicular to the length direction. The waveguide is supported on the substrate via a support structure extending from the substrate to the device layer. A device layer plane extends parallel to the substrate plane through the point of the device layer being supported via the support structure that is closest to the substrate plane. The side of the waveguide facing the substrate is at least partly free from contact with the support structure. The method is characterized in that it comprises the steps of providing a handling substrate on which a device layer is arranged, the handling substrate and the device layer forming a device layer assembly, providing a substrate and providing a contact layer on the substrate and/or on the device layer assembly, on the same side of the handling substrate as the device layer. The method also comprises the steps of attaching the device layer assembly on the substrate with the device layer arranged between the handling substrate and the substrate, removing the handling substrate after attachment of the device layer assembly to the substrate, removing material from the device layer to form the waveguide, and removing material between the device layer and the substrate to form the support structure, so that the side of the waveguide facing the substrate is at least partly free from contact with any solid material, so that the ratio of the largest distance Dl, perpendicular to the substrate plane, between a free surface of the waveguide facing the substrate and any solid material to the height h of the waveguide is more than 6, i.e. Dl/h>6, preferably Dl/h>8, and most preferred Dl/h>10, and so that the ratio of the distance D2, perpendicular to the substrate plane, between the device layer plane and the substrate plane to the height h of the waveguide is more than 6, i.e. D2/h>6, preferably D2/h>8, and most preferred D2/h>10.

This is a favorable method for fabricating a device according to the first aspect. By the method according to the second aspect stacks of layers may be produced, which are not feasible to produce otherwise. In the prior art silicon layers being supported on oxide supports on a silicon substrate have been possible to fabricate using so called silicon on insulator wafers (SOI wafers). As mentioned above the silicon device layer in SOI wafers is difficult to get stress free. The problem with inherent stresses in the silicon device layer becomes worse with increasing thickness of the insulator/oxide and decreasing thickness of the device layer. Furthermore, the specified values of Dl/h and D2/h are not possible to achieve using commercially available SOI wafers. The method a provides a stress-free device layer and hence a stress-free waveguide.

### BRIEF DESCRIPTION OF THE DRAWINGS

The features described in relation to the second aspect are combinable with the method according to the fourth aspect.

In the following description of preferred embodiments reference will be to the appended figures on which:

FIG. 1 shows in a top view a device comprising a waveguide supported on a substrate according to an embodiment;

FIG. 2 shows in a perspective sectional view a part of the device in FIG. 2 according to an embodiment;

FIG. 3 shows the cross-section A-A in FIG. 2 according to an embodiment;

FIG. 4 shows the cross-section A-A in FIG. 2 according to another embodiment;

FIG. 5a shows in a top view a part of a device according to an alternative embodiment;

FIG. 5b shows in a top view a part of a device according to an alternative embodiment;

FIG. 6 shows the cross-section B-B in FIGS. 5a and 5b;

FIG. 7 shows the cross-section C-C in FIGS. 5a and 5b according to two different embodiments;

FIG. 8 shows a cross-section of a part of a device according to two different embodiments; and

FIGS. 9a-9f illustrate the method for fabricating a device according to FIGS. 1-8.

### DETAILED DESCRIPTION OF ILLUSTRATIVE EMBODIMENTS

In the following description of embodiments of the invention the same reference numerals will be used for equivalent features in the different figures. The figures are not drawn to scale.

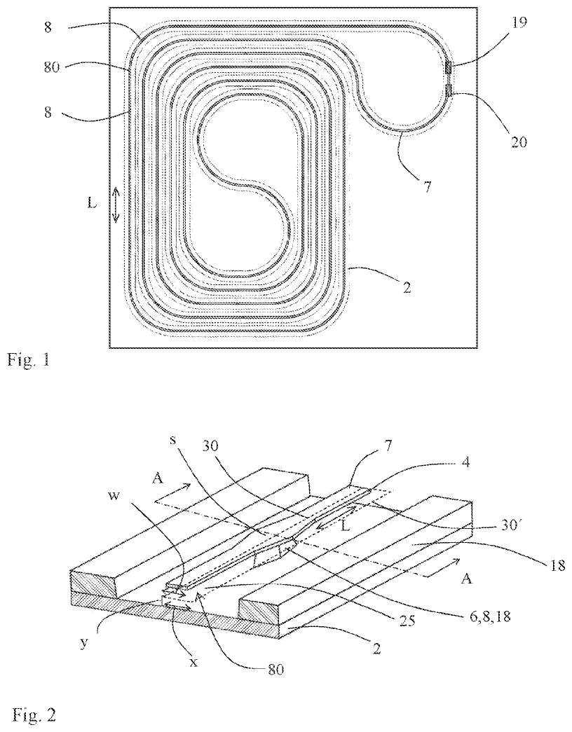

FIG. 1 shows in a top view a device 1 according to an embodiment. The device comprises a waveguide supported by support elements 8 on a substrate 2. The waveguide defines a closed circuit along a length direction L. FIG. 2 shows in a perspective sectional view a part of the device in FIG. 2 according to an embodiment.

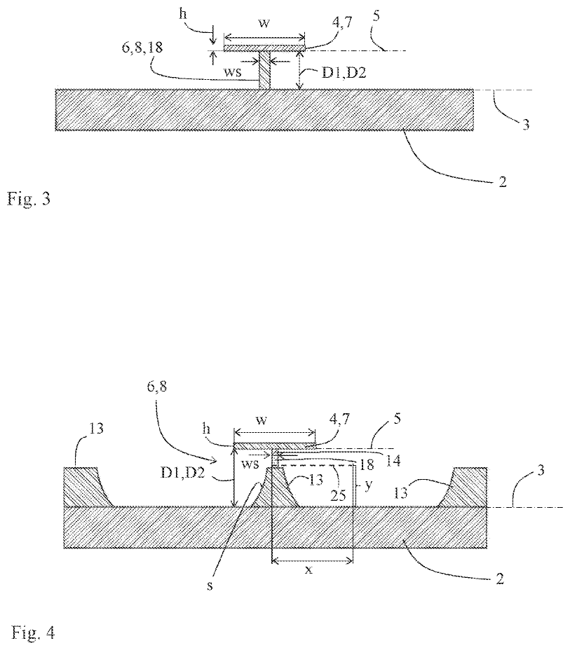

FIG. 3 shows the cross-section A-A in FIG. 2 according to an embodiment. The device will initially be described with reference to primarily FIGS. 2 and 3. The device 1 (FIG. 1) comprises, a device layer 4, a substrate 2 defining a substrate plane 3 extending through the point of the substrate 2 being closest to the device layer 4, and a waveguide 7 for guiding an electromagnetic wave. The side of the device layer 4 facing the substrate 2 defines a device layer plane 5 (FIG. 3). The waveguide extends in a length direction L (FIGS. 1 and 2) in the device layer 4. The waveguide 7 has a width w in the device layer plane 5 (FIG. 3) in a direction perpendicular to the length direction L, and a height h out of the device layer plane 5 (FIG. 3) in a direction perpendicular to the length direction L. The waveguide 7 is supported on the substrate 2 via a support structure 6 extending from the substrate 2 to the device layer 4. A device layer plane 5 extends parallel to the substrate plane 3 through the point of the device layer 4 being supported via the support structure 6 that is closest to the substrate plane. In the figures the device layer is perfectly flat resulting in the device layer plane 5 coinciding with the side of the device layer 4 facing the substrate 2. In the embodiment of FIGS. 1-3 the side of the waveguide 7 facing the substrate 2 is partly free from contact with the support structure, which is clearly visible in FIG. 2 wherein the support element 8, which forms part of the support structure 6, only extends along a limited length of the waveguide 7. The waveguide is free-hanging on both sides of the support element 8 in FIG. 2. Thus, the waveguide 7 comprises sections 80, separated in the length direction of the waveguide 7, which sections 80 are free from contact with any material on the surface facing the substrate 2.

The width w and height h of the waveguide determines a maximum wavelength that is suitable to transmit by the waveguide. The distance, perpendicular to the substrate plane 3, between the device layer plane 5 and the substrate plane 3, is denoted D2 in FIG. 3. The maximum distance, perpendicular to the substrate plane 3, consisting of free-space between the waveguide 7 and any solid material below the waveguide is denoted D1 in FIG. 3. In the embodiment shown in FIG. 3 D2 is equal to Dl. The device layer 7 is of a different material than a polymer, and the support structure 6 comprises a polymer layer 18. In FIGS. 2 and 3 the polymer layer 18 extends from the substrate 2 to the device layer 4 and is also in contact with the substrate 2 and the device layer 4. Thus, the support element 8 is made entirely of polymer. The device layer plane 5 is parallel to the substrate plane 3. Shown in FIG. 2 is a comparison cross section 25 which is parallel to the substrate plane 3, extends through the polymer layer 18 at a spacing y perpendicularly from the substrate plane 3, and extends perpendicularly to the length direction L to a breadth x, equal to the width w of the waveguide, from a side s of the support structure 6 being closest to the waveguide. The spacing y is chosen to maximize a ratio r of the area of the polymer layer within the comparison cross section 25 to the area of the support structure within the comparison cross

section 25. In this case the support structure is made entirely of a polymer and the ratio is 1 irrespective of the spacing y. The comparison cross section 25 extends along the entire length of the waveguide.

The device 1 shown in FIGS. 1-3 alleviates the problems with mechanical stresses in device layer 4 and the waveguide 7 irrespective of the distance D2 perpendicular to the substrate plane 3, between the device layer plane 5 and the substrate plane 3. The distance D2 can be made larger than 10 μm without introducing mechanical stresses in the device layer.

However, in order to alleviate also the problems with losses from the waveguide the maximum distance Dl, perpendicular to the substrate plane 3, consisting of free-space between the waveguide 7 and any solid material below the waveguide 7, should be at least 2 μm.

Another big advantage with having a polymer layer is that the device layer can be made thin. The ratio of the largest distance D1, perpendicular to the substrate plane 3, between a free surface of the waveguide 7 facing the substrate and any solid material to the height h of the waveguide 7 may be more than 6, i.e. Dl/h>6. Preferably Dl/h>8, and most preferred Dl/h>10. By having Dl/h>6, the losses due to leakage of energy from the waveguide to the substrate are very low for wavelengths suitable for the height. Also, the ratio of the distance D2, perpendicular to the substrate plane 3, between the device layer plane 5 and the substrate plane 3 to the height h of the waveguide 7 is more than 6, i.e. D2/h>6, preferably D2/h>8, and most preferred D2/h>10.

With a structure according to the embodiments in FIG. 2 and FIG. 3 the distance between the substrate 2 and the device layer 4 may be made considerably thicker than has been done in the prior art with almost no mechanical stresses in the device layer. Also, the losses from the waveguide are alleviated in comparison to the prior art due to the favorable properties of polymer with regard to affecting the electromagnetic wave in the adjacent waveguide 7. Also, in absolute quantities the distance D2, perpendicular to the device layer plane 5, between the device layer plane 5 and the substrate plane 3 can easily be manufactured to be bigger than 2 μm, preferably 3 μm, more preferably 30.1 μm, more preferably 4 μm, more preferably 6 μm, and most preferred 10 μm. Alternatively, it is of course possible to make the polymer layer thin. The polymer layer may be as thin as 5 nm.

The width ws of the support structure 6 at the point of support of the waveguide 7 is smaller than the width w of the waveguide 7 as can be seen in FIG. 3. It is possible to have the width ws of the support structure 6 at the point of support of the waveguide 7 larger than the width w of the waveguide 7.

FIG. 4 shows the cross-section A-A in FIG. 2 according to another embodiment. In contrast to the embodiment of FIG. 3 the device shown in FIG. 4 comprises more layers. More specifically 5 layers are shown in FIG. 4. The substrate 2 may be a silicon substrate and the device layer 4 and waveguide 7 may be of silicon. The layer 13 in contact with the substrate 2 may be a thick oxide layer. As is indicated by the parts of the thick oxide layer 13 on the sides the thick oxide layer may have covered the entire substrate before commencing fabrication of the device. The layer in contact with the waveguide 7 may be a metal layer 14. The metal layer 14 may be used during fabrication of the device. Finally, the layer between the thick oxide layer 13 and the metal layer 14 may be a polymer layer 18, which constitutes the contact layer 22, 23. The polymer layer 18 functions as a mechanical contact layer during fabrication of the device as will be evident from the description of the method below. Also, in this case, the ratio r is 1 as the polymer layer 18 extends from side to side of the support element 8.

The materials in the substrate 2, the support structure 6 and the device layer 4/waveguide 7, may be chosen from the materials indicated below. However, as is indicated by the different hatchings the material of the support structure 6 in contact with the device layer 4 is different from the material in the device layer, and the material of the support structure 6 in contact with the substrate 2 is different from the material in the substrate. Also, D1 and D2 are equal to each other in FIG. 4.

In the embodiments shown in FIGS. 2-4 the device layer 4 is equivalent to the waveguide 7. However, the term device layer more generally refers to the layer from which the waveguide is fabricated. Another common feature is that the device layer plane 5 is essentially parallel to the substrate plane 3.

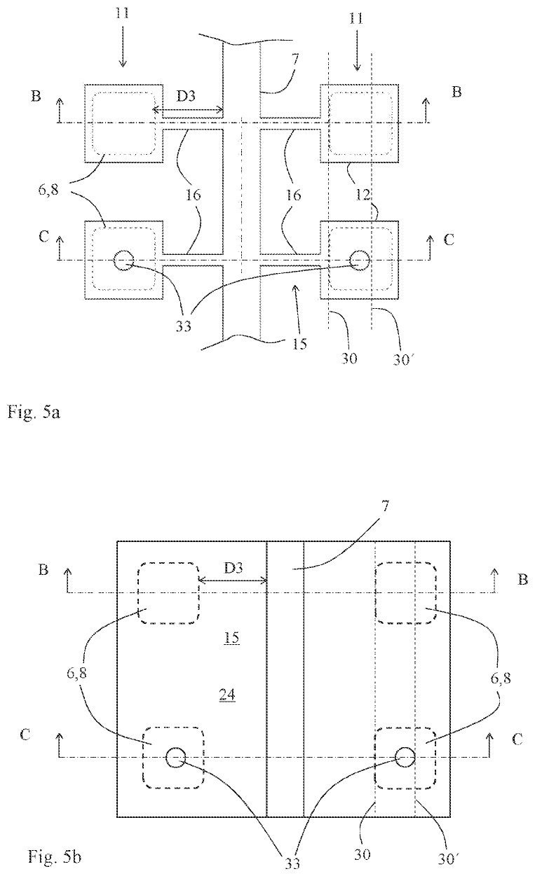

FIG. 5a shows in a top view a part of a device according to an alternative embodiment. In FIG. 5a the device layer 4 comprises a substructure 11, comprising a plurality of subelements 12 arranged at a distance from the waveguide 7, wherein the waveguide 7 is connected to the substructure 11 with connection means 15 in the device layer 4 in the form of a plurality of bridges 16. The support structure 6 is in the form of a plurality of support elements 8 which each extend from the substrate 2 to a respective subelement 12. The substructure 11 is connected to the waveguide 7 with a plurality of bridges 16, which each extend from the waveguide to a respective subelement 12. The support elements 8 comprise a polymer. The distance between the support structure 6 and the waveguide 7 is denoted D3 in FIGS. 5a and 5b. The ratio of said distance D3 to the width w of the waveguide 7 is about 2-3 in FIG. 5 but may be as big as 100 and as small as 1. FIG. 5b shows in a top view a part of a device according to an alternative embodiment. In FIG. 5b the connection means 15 are in the form of a continuous membrane 24. Due to the fabrication process of a membrane, the membrane 24 might contain holes (not shown) which are necessary if material needs to be removed underneath by under etching. The membrane 24 extends along each side of the waveguide 7 as is shown in FIG. 5b. The comparison cross section 25 extends between the two parallel lines 30, 30′ in FIG. 5a. The distance between the two lines 30, 30′, corresponds to the extension x of the comparison cross section 25. The extension x is equal to the width w of the waveguide. In FIGS. 5a and 5b two of the support elements comprises core elements 33 made of a conductive material. This will lead to a ratio r being less than 1. As the comparison cross section extends along the entire length of the waveguide it is not possible to determine the ratio r from FIGS. 5a and 5b. However, assuming that the pattern shown in FIGS. 5a and 5b repeats itself along the entire length of the waveguide, i.e., that every second pair of support elements comprise a core element 33 made of a conductive material, the ratio r is more than 0.95 in the embodiment shown in FIGS. 5a and 5b.

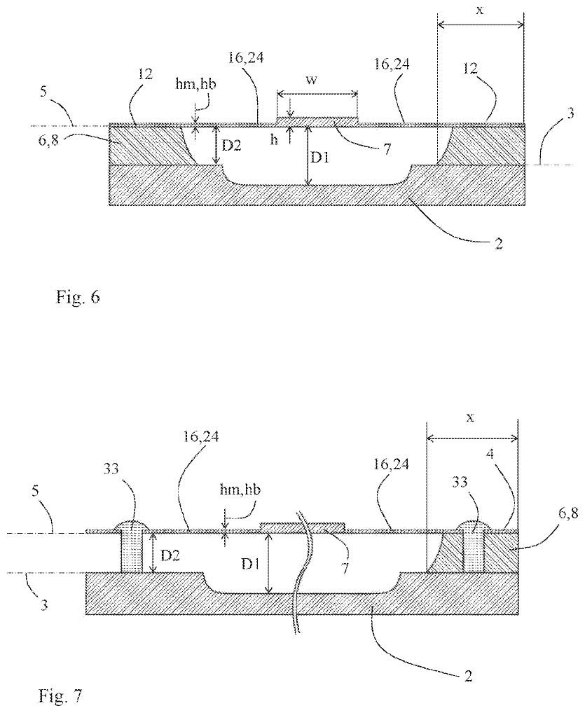

FIG. 6 shows the cross-section B-B in FIGS. 5a and 5b which both have the same cross sections. From FIG. 6 it is evident that the height hb, hm, of the bridges 16 and the membrane 24, respectively, is a smaller than the height h of the waveguide 7. This difference in height between the waveguide 7 and the connection means 15 will ensure proper confinement of the electromagnetic wave within the waveguide 7. It is also shown in FIG. 6 that material has been removed from the substrate 2 below the waveguide 7 resulting in that the maximum distance D1, perpendicular to the substrate plane 3, consisting of free-space between the waveguide 7 and any solid material below the waveguide is larger than the distance D2, perpendicular to the substrate plane 3, between the device layer plane 5 and the substrate plane 3. Thus, Dl>D2 in the embodiment shown in FIG. 6. The materials of the different layer can be chosen as described below. The height of the connection means in FIG. 6 is less than 80% of the height h of the device layer.

FIG. 7 shows the cross-section C-C of FIGS. 5a and b according to two different embodiments. In the embodiment to the left in FIG. 7 the support element 8 is made of metal and extends from the substrate through the device layer. In the embodiment to the right in FIG. 7 the support element 8 comprises a core element 33 made of a conductive material and extends from the substrate 2 through the device layer 4. The support element is also surrounded by a different material. When fabricating a support element as shown to the right the structure shown in FIG. 6 is first fabricated. A hole is then formed through the device layer and the support element 8.

Finally, the hole is filled with metal to arrive at the structure shown to the right in FIG. 7. In order to arrive at the support element shown to the left in FIG. 7 the material surrounding the core element 33 is removed. A metal connection between the substrate 2 and the device layer

is useful to provide an electrical connection between a device in the substrate 2 and a device in the device in the device layer 4.

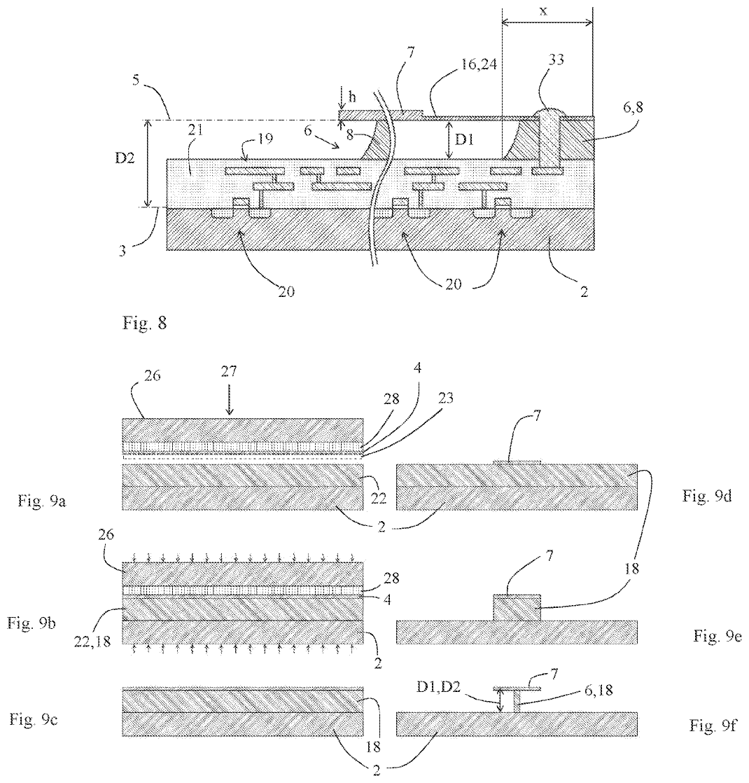

FIG. 8 shows a cross-section of a part of a device according to two different embodiments. The embodiments shown in FIG. 8 both comprise a substrate 2 on/in which metal lines 19 and different active devices 20 have been formed such as FETs (Field Effect Transistors). The metal lines 19 and the active devices 20 are embedded into an oxide layer.

The support elements 8 on top of the oxide layer 21 forms part of the support structure 6. The oxide layer 21 also forms part of the support structure 6. The oxide layer 21 and the support elements 8 together forms the support structure 6.

The comparison cross section 25 is indicated in FIGS. 2, 4, 6, 7, and 8, by its extension x perpendicularly to the length direction from a side of the support structure 6. The extension x is equal to the width w of the waveguide 7. The distance D3 between the waveguide 7 and the support elements 8 is slightly larger than the width w of the waveguide 7 in the embodiments shown in FIGS. 6-8.

In all embodiments described above it is advantageous to have the width w of the waveguide 7 at least 5 times the height h of the waveguide 7. By designing the waveguide in this way, the electromagnetic wave in the waveguide will be affected primarily by the top and bottom sides of the waveguide and to a smaller extent by the sides between the top and bottom sides. As it is easier to control the quality of the top and bottom sides said ratio will ensure a good quality of the waveguide.

In all embodiments described above the height h of the waveguide 7 is preferably smaller than the wavelength of the electromagnetic wave to be guided in order to better control the mode of the electromagnetic wave through the waveguide 7.

The embodiments are aimed at providing a device as defined in the claims, wherein the waveguide 7 is optimized for guiding an electromagnetic wave with a wavelength within the range of 0.4-100 μm, preferably 1.2-20 μm, and most preferred within 3-12 μm.

The devices described above may comprise metal lines 19 (FIG. 1) and/or active devices 20 (FIG. 1), such as transistors, light sources and detectors, in or in contact with the device layer 4 and/or the substrate 2.

FIG. 9a-9f illustrates a method for fabricating a device according to FIG. 3 according to an embodiment. The method starts with the provision of a handling substrate 26 on which a device layer 4 is arranged. In the example shown in FIG. 9a the handling substrate 26 is a silicon wafer which has been oxidized to produce an optional intermediate layer 28 in the form of a Si02-layer. A device layer 4 has then been fabricated on the intermediate layer 28. The handling substrate 26, the intermediate layer 28 and the device layer 4 form a device layer assembly 27. Also, a substrate 2 is provided on which a contact layer 22 is provided. As an alternative to the embodiment shown in FIG. 9 it is possible to provide a contact layer 23 on the handling substrate 26, in addition to or instead of the contact layer 22 on the substrate 2. This optional contact layer 23 is shown with dashed lines in FIG. 9a. As an example, the contact layer(s) 22, 23, may be polymer layers or oxide layers. Preferably, the contact layers 22, 23 may be polymer layers. Below is a list of possible polymers that may be chosen for the contact layer.

In a second step illustrated in FIG. 9b the device layer assembly 27 is attached on the substrate 2 with the device layer 4 arranged between the handling substrate 26 and the substrate 2, using the contact layer(s) as a connecting layer. The attachment of the device layer assembly 27 to the substrate 2 is performed by applying, e.g., a pressure and heat to the handling substrate 26 and the substrate 2. The application of heat and pressure should be interpreted broadly. A temperature as low as 20° C. and a pressure as low as 0.1 bar may be sufficient. Depending on the material used in the contact layer(s) 22, 23, the temperature and pressure applied may vary. When using polymer as contact layer(s) 22, 23, a suitable temperature interval is 20-500° C. Preferably, a temperature between 20-250° C. is used. A suitable pressure at the bond interface applied between 0.1-200 bar. When polymer is used as contact layer(s) 22, 23, the bonding can be performed in vacuum or atmospheric pressure. A polymer layer is advantageous as contact layer as the use of polymer might decrease losses in the waveguide due to reduced absorption. Further, the use of polymer enables wafer bonding at low temperatures which allows the use of substrates with low thermal budget, e.g., due to preprocessing or material properties. Also, polymer bonding allows joining of components of various material, which enables the use of these materials as waveguide, support structure and substrate. Certain combinations reduce the losses in the device and/or might reduce fabrication cost of the devices. That is partly due to the fact that a multitude of polymers can be applied in liquid/semi-liquid form using spin coating, which is a very easy and cheap process.

When using oxide as contact layer(s) 22, 23, the temperature used during bonding should be kept below 1200° C. Depending on the bonding method, a temperature between 15-400° C. or even 15-200° C. is used. The effective pressure at the bond interface applied during bonding can be zero or up to 200 Bar. Even if an oxide layer is not quite as easy to form as a polymer layer, an oxide layer is still quite easy to form. A benefit of having an oxide as the contact layer is that is more heat resistant than polymer. The higher heat resistance gives more freedom when choosing processing methods after formation of the contact layer.

Alternatively, the contact layer(s) 22, 23, may be formed as a metal layer. It is easy to form a metal layer, a metal layer is more heat resistant than a polymer layer, has more long-term stability than polymer and require lower bonding temperature than oxide bonding. Suitable metals for the contact layer are Copper, Gold and Aluminium. When using one of said metals as contact layer(s) 22, 23, the temperature used during bonding is preferably 20-450° C. A suitable pressure is 0.1-200 bar.

In a third step illustrated in FIG. 9c the handling substrate 26 and the optional intermediate layer 28 are removed after attachment of the device layer assembly 27 to the substrate 2.

Preferably, a suitable etching technique is used to remove the handling. The etching technique is chosen according to the material in the handling substrate 26.

In a fourth step illustrated by FIG. 9d material is removed from the device layer 4 to form the waveguide 7. The material in the device layer 4 is preferably removed using an etching technique adapted to the material in the device layer 4. As an alternative it is possible to form the waveguide 7 before the step of attaching the device layer assembly on the substrate 2.

In a fifth step illustrated by FIG. 9e and a sixth step illustrated by FIG. 9f material is removed

between the device layer and the substrate to form the support structure 6 as has been described above, so that the side of the waveguide 7 facing the substrate 2 is at least partly free from contact with any solid material, so that the ratio of the largest distance Dl, perpendicular to the substrate plane 3, between a free surface of the waveguide 7 facing the substrate and any solid material to the height h of the waveguide 7 is more than 6, i.e. Dl/h>6, preferably Dl/h>8, and most preferred Dl/h>10, and so that the ratio of the distance D2, perpendicular to the substrate plane 3, between the device layer plane 5 and the substrate plane 3 to the height h of the waveguide 7 is more than 6, i.e. D2/h>6, preferably D2/h>8, and most preferred D2/h>10. The material between the device layer 4 and the substrate 2 is preferably removed in a two-step process. In a first removal step illustrated by FIG. 9e the material in the contact layer(s) 22, 23, is removed on the sides of the waveguide by a vertical etching method. In a second removal step illustrated by FIG. 9f material is removed below the waveguide 7 using under-etching in order to form the support structure 6. The support structure 6 is formed to extend from the substrate 2 to the waveguide 7.

As an alternative the forming of the support structure may be performed before the step of removing the handling substrate. According to this alternative the support structure is preferably formed before attachment of the device layer assembly 27 on the substrate 2.

The method may also comprise the steps of forming, in the device layer 4, a substructure 11 arranged at a distance from the waveguide 7, and forming, in the device layer 4, connection means 15 with which the waveguide 7 is connected to the substructure 11. The support structure 6 is formed to extend from the substrate 2 to the substructure 11. In order to arrive at the device according to FIGS. 5a and 6 the substructure 11 is formed as a plurality of subelements 12, and the connection means 15 is formed as a plurality of bridges 16.

In order to arrive at the device according shown to the right in FIG. 7 the method comprises the steps of removing material in regions between the substructure 4 and the substrate 2 and forming a core element 33 in each one of said regions. The core elements 33 may comprise a conductive material. In order to arrive at the device shown to the left in FIG. 7 the material surrounding the core element 33 is removed to arrive at a support element 8 being constituted by the core element 33.

The thickness chosen for the contact layer(s) 22, 23, depends on many different parameters. Preferably, the thickness of the contact layer is in the interval 5 nm to 100 μm. The low part of the interval requires the support structure 6 to be constituted by other materials apart from the contact layer(s) 22, 23, as is shown in FIG. 4. A useful choice of material for the contact layer is a polymer. A thickness in the interval 5 nm-100 μm, constitutes the extremes of what is possible with adhesive bonding e.g. by using a bonding polymer. However, in order to provide a reliable contact layer(s) 22, 23, the thickness of the polymer contact layer(s) is preferably 200 nm-50 μm, most preferably 3-20 μm. A thickness in the interval 200 nm-so urn are the commonly used thicknesses for adhesive bonding with a polymer. With a thickness in the interval 3-20 urn the support structure might consist entirely of polymer and the separation between waveguide and substrate allows the application in gas sensing. If a polymer thicker than 100 μm is used, the mechanical stability of the device might become critical.

As is shown in FIG. 8 the method may comprise the step of forming metal lines 19 and/or active devices 20, such as transistors, light sources and detectors, in or in contact with the substrate 2 and/or the device layer 4 and/or between the device layer 4 and the substrate 2.

Lists of Materials for the Different Layers

In the following lists of suitable materials for the different layers will be displayed.

The material in the waveguide 7, i.e., device layer 4, may be chosen from the following materials:

silicon, silicon germanium, germanium, silicon nitride, lll-V materials, such as GaAs, InP, InGaAs, and InGaP, chalcogenide glass, indium(l11)-fluorid, diamond, sapphire, lithium niobate and other nonlinear materials, piezoelectric materials.

The material in the substrate 2 may be chosen from the following materials:

silicon, CMOS, glass (Si02-based glasses), germanium, polymer sapphire, III-V materials, such as GaAs, InP, InGaAs, InGaP, etc., diamond, metals, silicon carbide

The material between the substrate and the device layer might be a combination of different materials stacked horizontally or vertically. These different materials may be chosen from the following materials:

polymer, metals (TiW, Ni, Au, W, Al, Cr, Ti, Cu, Ag), dielectrics (Si02, SiN, Al203), semiconductors such as, e.g., Si, SiGe.

The polymer may be chosen from the following materials polymer adhesives, thermoplastic polymers, thermoset polymers, elastomers, hybrid polymers, specific polymer adhesives such as, e.g., BCB, nanoimprint resist, epoxy, SU8, PDMS, and PMMA.

The invention is not limited to the described embodiments but may be amended in many ways without departing from the scope of the invention, which is limited only by the appended claims.

1.-36. (canceled)

37. A device comprising:
a device layer;
a substrate defining a substrate plane extending through a point of the substrate being closest to the device layer;
a waveguide configured to guide an electromagnetic wave, wherein the waveguide extends in a length direction in the device layer, and wherein the waveguide has a width in a device layer plane in a direction perpendicular to the length direction and a height out of the device layer plane in the direction perpendicular to the length direction; and
a support structure,
wherein the support structure extends from the substrate to the device layer to support the waveguide on the substrate,
wherein the device layer plane extends parallel to the substrate plane through the point of the device layer being supported via the support structure that is closest to the substrate plane,
wherein the device layer is of a different material than a polymer,
wherein the support structure comprises a polymer layer,
wherein a comparison cross section extends parallel to the substrate plane through the polymer layer at a spacing perpendicularly from the substrate plane and extends perpendicularly to the length direction to a breadth, equal to the width of the waveguide, from a side of the support structure being closest to the waveguide,
wherein the spacing is chosen to maximize a ratio of an area of the polymer layer within the comparison cross section to an area of the support structure within the comparison cross section, and
wherein the ratio is at least 0.5.

38. The device according to claim 37, wherein the device layer is essentially parallel to the substrate plane.

39. The device according to claim 37, wherein the polymer layer is in contact with the device layer.

40. The device according to claim 37, wherein the device layer comprises a substructure, comprising at least one subelement, arranged at a distance from the waveguide, wherein the waveguide is connected to the substructure with a connector in the device layer, and wherein the support structure extends from the substrate to the substructure.

41. The device according to claim 40, wherein the substructure comprises a plurality of subelements.

42. The device according to claim 40, wherein the support structure comprises a plurality of support elements extending from the substrate to the substructure.

43. The device according to claim 40, wherein the connector comprises a plurality of bridges connecting the waveguide with the substructure.

44. The device according to claim 37, wherein the support structure extends from the substrate to the waveguide.

45. The device according to claim 44, wherein a width of the support structure at a point of support of the waveguide is smaller than the width of the waveguide.

46. The device according to claim 44, wherein the support structure comprises a plurality of support elements such that the waveguide is free-hanging between two adjacent support elements.

47. The device according to claim 46, wherein at least one of the support elements is made entirely of a polymer.

48. The device according to claim 37, wherein the waveguide comprises at least sections, separated in the length direction of the waveguide, and wherein the sections are free from contact with any material on a surface facing the substrate.

49. A method for fabricating a device comprising a device layer, a substrate defining a substrate plane extending through a point of the substrate being closest to the device layer, a waveguide for guiding an electromagnetic wave, wherein the waveguide extends in a length direction in the device layer, wherein the waveguide has a width in a device layer plane in a direction perpendicular to the length direction and a height out of the device layer plane in the direction perpendicular to the length direction, and a support structure, wherein the support structure extends from the substrate to the device layer to support the waveguide on the substrate, and wherein the device layer plane extends parallel to the substrate plane through a point of the device layer being supported via the support structure that is closest to the substrate plane, the method comprising:
providing a handling substrate on which a device layer is arranged, the handling substrate and the device layer forming a device layer assembly;
providing the substrate;
providing a polymer contact layer on the substrate and/or on the device layer assembly on the same side of the handling substrate as the device layer;
attaching the device layer assembly to the substrate with the device layer arranged between the handling substrate and the substrate so that the polymer contact layer forms a polymer layer;
removing the handling substrate after attaching the device layer assembly to the substrate;
removing a material from the device layer to form the waveguide; and
removing a material from the polymer contact layer to form the support structure,
wherein the device layer is of a different material than a polymer,
wherein the support structure comprises the polymer layer,
wherein a comparison cross section extends, parallel to the substrate plane through the polymer layer at a spacing perpendicularly from the substrate plane, and extends perpendicularly to the length direction to a breadth, equal to the width of the waveguide, from a side of the support structure being closest to the waveguide,
wherein the spacing is chosen to maximize a ratio of an area of the polymer layer within the comparison cross section to an area of the support structure within the comparison cross section, and
wherein the ratio is at least 0.5.

50. The method according to claim 49, wherein forming the waveguide is performed after removing the handling substrate.

51. The method according to claim 49, wherein forming the support structure is performed after removing the handling substrate.

52. The method according to claim 49, wherein a thickness of the polymer layer is formed to be in an interval of 5 nm to 100 μm inclusive.

53. The method according to claim 49, further comprising:
forming, in the device layer, a substructure comprising at least one subelement arranged at a distance from the waveguide; and
forming, in the device layer, a connector with which the waveguide is connected to the substructure,
wherein the support structure is formed to extend from the substrate to the substructure.

54. The method according to claim 49, wherein the support structure is formed to extend from the substrate to the waveguide.

55. The method according to claim 49, further comprising forming metal lines and/or active devices in or on the device.

56. The method according to claim 49, further comprising removing a material from the substrate below the waveguide.
